(19) United States
(12) Patent Application Publication
(10) Pub. No.: US 2026/0338158 A1
(43) Pub. Date: Oct. 29, 2026

(54) CONTROLLING ACTIVATION OF A DRIVE TRAIN BRAKE IN A WIND TURBINE

(71) Applicant: VESTAS WIND SYSTEMS A/S, Aarhus N (DK)

(72) Inventors: Lars Rohrmann ANDERSEN, Hadsten (DK); Esben BACH-SØRENSEN, Hobro (DK); Lars BILLER, Beder (DK)

(21) Appl. No.: 19/107,943

(22) PCT Filed: Sep. 1, 2023
(86) PCT No.: PCT/DK2023/050211

§ 371 Date: Feb. 28, 2025

(30) Foreign Application Priority Data
Sep. 2, 2022 (DK) PA202270429

(51) Int. Cl. F03D 7/02; F03D 7/04; F03D 17/00

(52) U.S. Cl. CPC F03D 7/0248; F03D 7/0264; F03D 7/047; F03D 17/0065

(57) ABSTRACT

The invention provides a controller (100) for a wind turbine (1) having a plurality of control nodes (110, 120), a drive train (54), a drive train brake, and a drive train brake activation unit (56). The controller (100) is configured to receive a drive train brake request, to verify a diagnostic status of at least one control node (120) of the plurality of control nodes other than a control node (110) providing the drive train brake request, to determine a drive train brake activation signal, based on the received drive train brake request and the verified diagnostic status, and to control operation of the drive train brake activation unit based on the drive train brake activation signal.

### TECHNICAL FIELD

The invention relates to a controller for a wind turbine having a plurality of control nodes, a drive train, a drive train brake, and a drive train brake activation unit, the controller being configured to control operation of the drive train brake activation unit.

### BACKGROUND

Wind turbines as known in the art include a wind turbine tower supporting a nacelle and a rotor with a number of—typically, three-pitch—adjustable rotor blades mounted thereto. When the wind turbine is not in operation, a mechanical brake may be applied to avoid that the rotor starts rotating unintentionally. To avoid standstill marks or false brinelling, the rotor is typically allowed to freely rotate over at least a small angle when the wind turbine is not in operation. However, in certain situations, e.g. during commissioning of the wind turbine or when service work is done to the drive train, the drive train brake may be applied to ensure that the rotor does not rotate. This is important for the safety of the operator as well as for facilitating the commissioning or service work.

EP3645867 discloses aspects relating to protection of the mechanical brake, hereunder avoiding activating the brake when personnel are not present in the wind turbine. After receipt of an emergency stop signal it is determining whether or not a person is present within the wind turbine, and if a person is not present, the emergency stop signal is validated allowing the brake to activate.

It is against this background that the present invention is set.

### SUMMARY OF THE INVENTION

According to an aspect of the invention there is provided a controller for a wind turbine having a plurality of control nodes, a drive train, a drive train brake, and a drive train brake activation unit. The controller is configured to receive a drive train brake request, to verify a diagnostic status of at least one control node of the plurality of control nodes other than a control node providing the drive train brake request, to determine a drive train brake activation signal, based on the received drive train brake request and the verified diagnostic status, and to control operation of the drive train brake activation unit based on the drive train brake activation signal.

The inventors have observed that a too frequent or prolonged application of the drive train brake still causes damage to the gears and bearings of the drive train and may result in expensive replacement operations of the gearbox or parts thereof. With the controller according to the invention, an extra check is built in for ensuring that the drive train brake is only applied when, based on a diagnostic analysis of the broader wind turbine safety and control system, it has been verified that the drive train brake request (hereinafter also called ‘brake request’) is a valid request. As a result, erroneous application of the drive train brake is avoided, or at least severely limited and the occurrence of standstill marks and false brinelling is significantly reduced. In this manner it is possible to limit erroneous activation of the drivetrain brake due to an error in the communication network or electrical system. It is advantageous to control the activation of the drive train brake based on the received drive train brake request and the verified diagnostic status since it is thereby ensured that the actual activation of the drive train brake is made only based on a valid request directed to the drive train brake activation, irrespective of status and validity of other control signals.

In embodiments, the diagnostic status is verified by a diagnostic monitoring system implemented by the control system, preferably in a safe domain of the control system. The validation may be based on signal analysis, e.g. by analysis of error codes in control signals and by verifying that expected signals are sent from pre-specified control nodes and received at pre-specified control nodes.

In embodiments, the control system may comprise a rule-based verification system to verify the diagnostic status, e.g. implemented by the diagnostic monitoring system. The rule-based verification system may implement a set of conditions to be fulfilled defining the diagnostic status. Such conditions may comprise operational statuses of control nodes and results of control signal analysis. The rule-based verification system may be implemented in a configurable setup, allowing a system operator to reconfigure the rules to cover unintentional applications of the drive train brake not earlier been accounted for.

In exemplary embodiments, the plurality of control nodes comprises an emergency stop system and the drive train brake request is received from the emergency stop system. While, previously, all such brake requests would have resulted in the drive train brake being applied, the brake request is now first validated by verifying the diagnostic status of at least one other control node. Only when it is clear that the brake request is valid and not a result of, for example, a technical issue elsewhere in the wind turbine safety and control system, the drive train brake is actually applied.

If, for example, when verifying the diagnostic status of other control nodes, it appears that an access door has been locked from the outside, or no persons have been present in the area for a set amount of time (e.g., 30 minutes). The brake activation signal can be declared invalid, and the brake may not be applied. Similarly, if signals from other nodes in the safety and control system indicate certain network communication errors or power failures, the perceived drive train brake request from the emergency stop system may be deemed invalid and the drive train brake is not activated.

The emergency stop system may be configured to be activated by a person entering an area in proximity to the drive train. For example, the emergency stop system may be functionally coupled to a door lock that can only be opened after having activated the emergency stop system. Alternatively, the emergency stop system may be automatically triggered when opening a door, or when a motion detector detects the presence of an operator in the area proximate to the drive train. Typically, the operator needs to de-activate the emergency stop system after having left the area, to thereby indicate that the drive train brake can be released. If the operator fails to de-activate the emergency stop system, the drive train brake is applied unnecessarily long, and the drive train may be damaged as a result.

In some embodiments, the verified diagnostic status includes a time elapsed since receiving the drive train brake activation request. To avoid the drive train brake to be applied for too long, leading to damage to the drive train, the drive train brake activation signal may be changed from high to low automatically after a set amount of time. This set amount of time may, e.g., be 20 minutes, 30 minutes, or 40 minutes.

The plurality of control nodes may comprise one or more network communication switches. The verified diagnostic status may further include a software error of the at least one control node. Communication errors received from communication switches or software errors from one of the many control nodes in the wind turbine control network may indicate that any received drive train brake request could have been received in error and should not be reacted to with a drive train brake activation signal. Similarly, the verified diagnostic status may include a low-power status of one or more control nodes or a network time-out for a data packet sent to and/or received by the at least one control node. Such low power status signals and network time-outs may be caused by events that also led to an erroneous drive train brake request. Therefore, the controller of the wind turbine first verifies the diagnostic status of the at least one control node, before deciding whether to send out the drive train brake activation signal.

According to a further aspect of the invention, a wind turbine is provided comprising a controller as described above.

According to yet another aspect of the invention, a method is provided for a wind turbine having a plurality of control nodes, a drive train, a drive train brake, and a drive train brake activation unit. The method comprises the steps of receiving a drive train brake request, verifying a diagnostic status of at least one control node of the plurality of control nodes other than a control node providing the drive train brake request, determining a drive train brake activation signal, based on the received drive train brake request and the verified diagnostic status, and controlling operation of the drive train brake activation unit based on the drive train brake activation signal.

### BRIEF DESCRIPTION OF THE DRAWINGS

Examples of the invention will now be described with reference to the accompanying drawings, in which:

FIG. 1 schematically illustrates a wind turbine in accordance with an aspect of the invention.

FIG. 2 shows a wind turbine rotor hub with a control system in accordance with an embodiment of the invention.

FIG. 3 SHOWS A FLOW CHART OF A CONTROL METHOD IN ACCORDANCE WITH AN EMBODIMENT OF THE invention.

### DETAILED DESCRIPTION

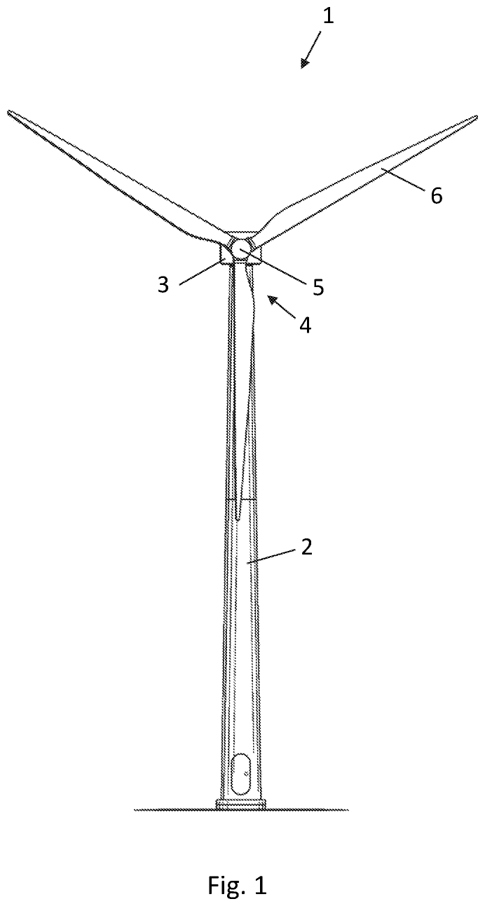

FIG. 1 illustrates, in a schematic view, an example of a wind turbine 1. The wind turbine 1 includes a tower 2, a nacelle 3 disposed at the apex of, or atop, the tower 2, and a rotor 4 operatively coupled to a generator housed inside the nacelle 3. In addition to the generator, the nacelle 3 houses other components required for converting wind energy into electrical energy and various components needed to operate, control, and optimise the performance of the wind turbine 1. The rotor 4 of the wind turbine 1 includes a central hub 5 and three rotor blades 6 that project outwardly from the central hub 5. Moreover, the wind turbine 1 comprises a control system or controller (not shown in FIG. 1). The controller may be placed inside the nacelle 3, in the tower 2 or distributed at several locations inside (or externally to) the turbine 1 and communicatively connected to one another. The rotor blades 6 are pitch-adjustable. The rotor blades 6 can be adjusted in accordance with a collective pitch setting, where each of the blades are set to the same pitch value. The rotational speed of the rotor 4 can be increased by pitching the rotor blades 6 into the wind or reduced by pitching out.

When the wind turbine 1 is not in operation, a mechanical brake may be applied to avoid that the rotor 4 starts rotating unintentionally. To avoid standstill marks or false brinelling, the rotor 4 is preferably allowed to freely rotate over at least a small angle when the wind turbine 1 is not in operation. However, during commissioning of the wind turbine 1 and when service work is done to the drive train, a drive train brake may be applied to ensure that the rotor 4 does not rotate. This is important for the safety of the operator as well as for facilitating the commissioning or service work.

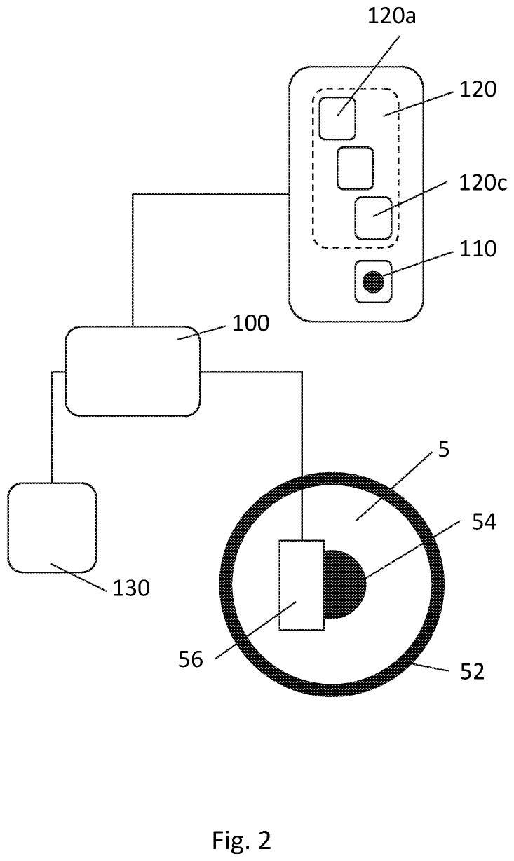

FIG. 2 schematically shows elements of a wind turbine with a control system in accordance with an embodiment of the invention. A rotor hub 5 is rotatably supported by a rotor bearing 52. The drive train 54 couples the rotor hub 5 to a generator that converts the rotary motion of the rotor 4 to electricity. A brake activation unit 56 is provided to apply and release a drive train brake (not shown) upon request from a brake controller 100. In exemplary embodiments, the drive train brake is applied when a hydraulic inlet valve is energised, while a hydraulic drain valve is de-energised. The hydraulic brake pressure may be stored in a separate brake accumulator. In alternative embodiments, different hydraulic or non-hydraulic brake actuation systems may be used. The brake controller 100 of the here shown control system is preferably powered by a UPS (Uninterruptable Power Supply) 130, which is coupled to the power grid (not shown). The UPS 130 ensures that the drive train brake can still be applied when the power supply to other parts of the control system is interrupted. The drive train brake may be positioned at an appropriate location, typically in or near the generator. The drive train brake may be of a disc brake type being braked by electrical or hydraulic brake calipers.

The control system further comprises a plurality of control nodes 110, 120 for controlling various control and safety functions of the wind turbine 1. One of the control nodes may be an emergency stop system 110 that, when activated, sends a brake request to the brake controller 100. The emergency stop system 110 may not exclusively be used for applying the drive train brake in the event of an emergency, but may also be activatable on purpose, for example, when an operator needs to be close to drive train 54 for performing servicing or commissioning tasks. Alternatively, a separate servicing stop system 120c is provided for the purpose of controlled application and release of the drive train brake in planned non-emergency situations wherein the drive train brake is operated to allow for save servicing operations.

The emergency stop system 110 may be configured to be activated by a person entering an area in proximity to the drive train 54. The emergency stop system 110 may, e.g., comprise an emergency stop button or switch that is to be operated by the user. The emergency stop system 110 may be functionally coupled to a door lock that can only be opened after activation of the emergency stop system 110. Alternatively, the emergency stop system 110 may be automatically triggered when opening a door, or when a motion detector detects the presence of an operator in the area proximate to the drive train 54.

In addition to the emergency stop system 110, the control system comprises a plurality of further control nodes 120, which may, e.g., comprise network communication switches 120a, control units for controlling the various technical functions of the wind turbine 1, and all kinds of sensors for monitoring the operation of the wind turbine 1 and the area inside and surrounding the nacelle 3. Preferably, the emergency stop system 110 has a direct connection to the brake controller 100 to ensure that it can cause the activation of the drive train brake in the event of, for example, electronic failures in the network communication switches 120a or in other control nodes 120. It is noted that brake requests may not have to come from the emergency stop system 110 but can come from the servicing stop system 120c or from other parts of the wind turbine control system too. Alternatively, a brake request originates from outside the wind turbine 1, such as from an external operator, or from a power plant control system.

The inventors have observed that a too frequent or prolonged application of the drive train brake may cause damage to the rotor bearing 52 and other bearings or gears of the drive train. This may result in expensive replacement operations of the gearbox or parts thereof. In the brake controller 100 of the embodiment of FIG. 2, an extra check is built in for ensuring that the drive train brake is only applied when, based on a diagnostic analysis of the broader wind turbine safety and control system, it has been verified that the received brake request is valid. As a result, erroneous application of the drive train brake is avoided, or at least severely limited and the occurrence of standstill marks and false brinelling is significantly reduced.

If, for example, when verifying the diagnostic status of other control nodes 120, it appears that an access door has been locked from the outside, or no persons have been present in the area for a set amount of time (e.g., 30 minutes). The brake activation signal can be declared invalid, and the drive train brake may not be applied. Similarly, if signals from other nodes 120 in the safety and control system indicate certain network communication errors or power failures, the drive train brake request received from the emergency stop system 110 may be deemed invalid and the drive train brake is not activated.

The verified diagnostic status may include a software error of the at least one control node 120. Communication errors received from communication switches 120a or software errors from one of the many control nodes 120 in the wind turbine control network may indicate that any received drive train brake request could have been received in error and should not be reacted to with a drive train brake activation signal. Similarly, the verified diagnostic status may include a low-power status of one or more control nodes 120 or a network time-out for a data packet sent to and/or received by the at least one control node 120. Such low power status signals and network time-outs may be caused by events that also led to an erroneous drive train brake request. Therefore, the brake controller 100 of the wind turbine first verifies the diagnostic status of the at least one control node 120, before deciding whether to send out the drive train brake activation signal. The brake request thus needs to be validated before the brake activation unit 56 is instructed to apply the drive train brake.

When the commissioning or service work on the drive train 54 is completed, the operator leaves the area nearby the drive train 54. Typically, the operator needs to de-activate the servicing stop system 120c and/or the emergency stop system 110 after having left the area, to thereby indicate that the drive train brake can be released. If the operator fails to do this, the drive train brake is applied unnecessarily long, and the drive train may be damaged as a result.

In some embodiments, the verified diagnostic status includes a time elapsed since receiving the drive train brake activation request. To avoid the drive train brake to be applied for too long, leading to damage to the drive train bearings, the drive train brake activation signal may be changed from high to low automatically after a set amount of time. This set amount of time may, e.g., be 20 minutes, 30 minutes, or 40 minutes.

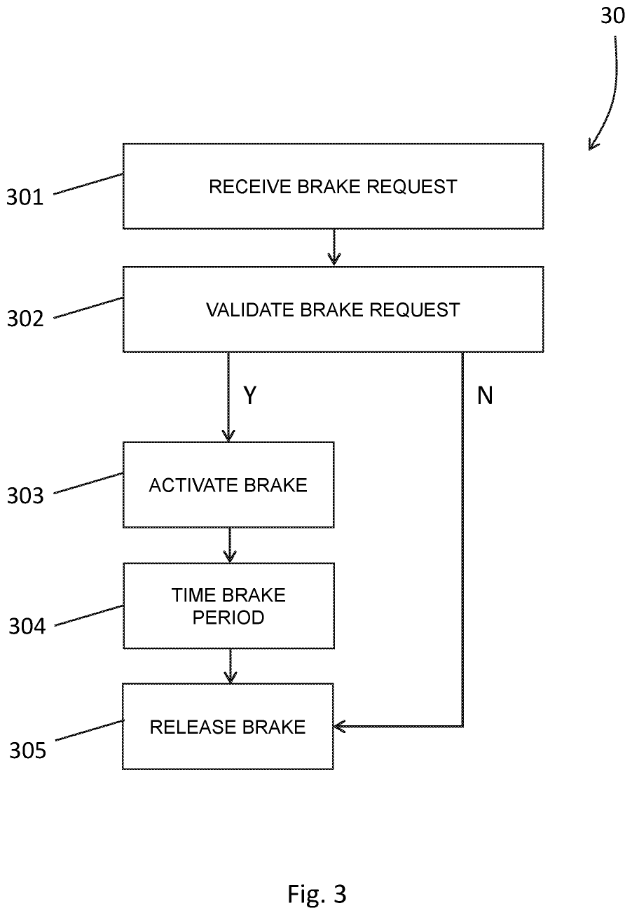

FIG. 3 shows a flow chart of a control method 30 in accordance with an embodiment of the invention. The control method 30 illustrated herein, may be executed by the drive train brake controller 100 of the control system of FIG. 2. In a first step 301, the brake controller 100 receives a drive train brake request. This drive train brake request may come from the emergency stop system 110, from the servicing stop system 120c, or from a different safety system of the wind turbine 1. Alternatively, the drive train brake request may be received from a remote device, such as a smartphone or service tool of a wind turbine operator, or a wind turbine plant control centre. In some embodiments, the validation of the drive train brake request may involve requiring a second drive train brake request from an independent source. For example, a remote drive train brake request from a service tool of the operator is only validated if the verified diagnostic status of the plurality of control nodes 110, 120, includes a confirmation that the emergency stop system has been activated.

In a second step 302, the brake controller 100 verifies a diagnostic status of at least one control node 120 of the plurality of control nodes 120. If in this verification step 302, the drive train brake request is determined to be valid (Y), the brake controller 100 sends out its drive train brake activation signal. If the drive train brake request is determined to be invalid (N), the brake controller 100 may send out a drive train brake release signal, or no signal at all if the drive train brake is already in an inactive state. When receiving the drive train brake request, in a third step 303, the drive train brake activation unit 56 applies the drive train brake to prevent the wind turbine rotor 4 from rotating.

As already described above, a timer may be started when the drive train brake is applied. In a fourth step 304, the drive train brake controller 100 monitors the time elapsed since the application of the drive train brake. After a predetermined amount of time, the drive train brake may then release the drive train brake in a final, fifth step 305. Like the activation of the drive train brake, the release of the brake may be dependent on a diagnostic status of at least one of the control nodes 110, 120. For example, is a motion sensor detects the presence of a person in the direct vicinity of the drivetrain 54, the drive train brake may not be released, and the timer may be restarted. More advanced brake release algorithms may use different validation criteria based on, for example, the amount of time elapsed sins the application of the drive train brake.

1. A controller for a wind turbine having a plurality of control nodes, a drive train, a drive train brake, and a drive train brake activation unit, the controller being configured to:
receive a drive train brake request,
verify a diagnostic status of at least one control node of the plurality of control nodes other than a control node providing the drive train brake request,
determine a drive train brake activation signal, based on the received drive train brake request and the verified diagnostic status, and
control operation of the drive train brake activation unit based on the drive train brake activation signal.

2. A controller according to claim 1, wherein the plurality of control nodes comprises an emergency stop system and wherein the drive train brake request is received from the emergency stop system.

3. A controller according to claim 2, wherein the emergency stop system is configured to be activated by a person entering an area in proximity to the drive train.

4. A controller according to claim 1, wherein the verified diagnostic status includes a time elapsed since receiving the drive train brake activation request.

5. A controller according to claim 1, wherein the plurality of control nodes comprises one or more network communication switches.

6. A controller according to claim 1, wherein the verified diagnostic status includes a software error of the at least one control node.

7. A controller according to claim 1, wherein the verified diagnostic status includes a low-power status of the at least one control node (120).

8. A controller according to claim 1, wherein the verified diagnostic status includes a network time-out for a data packet sent to and/or received by the at least one control node

9. A controller according to claim 1, wherein the diagnostic status is verified by a diagnostic monitoring system implemented by the control system.

10. A controller according to claim 1, further comprising a rule-based verification system implemented to verify the diagnostic status.

11. (canceled)

12. A method for a wind turbine having a plurality of control nodes, a drive train, a drive train brake, and a drive train brake activation unit, the method comprising:
receiving a drive train brake request,
verifying a diagnostic status of at least one control node of the plurality of control nodes other than a control node providing the drive train brake request,
determining a drive train brake activation signal, based on the received drive train brake request and the verified diagnostic status, and
controlling operation of the drive train brake activation unit based on the drive train brake activation signal.

13. A non-transitory, computer-readable storage medium storing instructions thereon that when executed by one or more processors cause the one or more processors to execute an operation of a wind turbine having a plurality of control nodes, a drive train, a drive train brake, and a drive train brake activation unit, the operation comprising:
receiving a drive train brake request;
verifying a diagnostic status of at least one control node of the plurality of control nodes other than a control node providing the drive train brake request,
determining a drive train brake activation signal, based on the received drive train brake request and the verified diagnostic status; and
controlling operation of the drive train brake activation unit based on the drive train brake activation signal.

14. A wind turbine, comprising:
a tower;
a nacelle disposed on the tower;
a plurality of control nodes;
a drive train;
a drive train brake operable to brake the drive train will;
a drive train brake activation unit communicatively coupled to the drive train brake; and
a controller, configured to perform an operation, comprising:
receiving a drive train brake request from a given control node of the plurality of control nodes;
verifying a diagnostic status of at least one control node of the plurality of control nodes other than the given control node,
determining a drive train brake activation signal, based on the received drive train brake request and the verified diagnostic status; and
controlling operation of the drive train brake activation unit based on the drive train brake activation signal.
